(19) United States
(12) Patent Application Publication
(10) Pub. No.: US 2007/0300156 A1
(43) Pub. Date: Dec. 27, 2007

(54) MULTI-LINGUAL DYNAMIC ASSIGNMENT AND MANAGEMENT OF USER INTERFACE LABEL MNEMONICS

(75) Inventors: David Taieb, Charleston, MA (US); Tomen Tse, Raleigh, NC (US); Yoshito Umaoka, Chelmsford, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/426,100

(22) Filed: Jun. 23, 2006

(51) Int. Cl. G06F 9/00

(52) U.S. Cl. 715/703; 715/764; 715/810

(57) ABSTRACT

Embodiments of the present invention address deficiencies of the art in respect to mnemonic labels and provide a method, system and computer program product for multi-lingual dynamic assignment and management of user interface label mnemonics. In one embodiment of the invention, a dynamic label mnemonic assignment method can be provided. The method can include generating a run-time set of label mnemonics for a set of labels in a user interface for a computer program, determining if any of the run-time generated label mnemonics are not unique for the set of label mnemonics, and responsive to determining that any of the run-time generated label mnemonics are not unique for the set of label mnemonics, generating a different set of label mnemonics for the set of labels.

### BACKGROUND OF THE INVENTION

1. Field of the Invention

The present invention relates to the field of user interface configuration and more particularly to the assignment and management of multi-lingual label mnemonics.

2. Description of the Related Art

For more than ten years, computer scientists and engineers have addressed the accessibility of the computer program user interface—particularly for the benefit of those end users unable to interact with a computer program utilizing conventional means such as a mouse or keyboard. Presently, several assistive technologies have been widely distributed, usually in concert with the distribution of an operating system, to provide one or more alternative user interface mechanisms for the purpose of enhanced accessibility. Examples of assistive technologies include an audio user interface such as a screen reader.

Assistive technologies are part and parcel of accessibility requirements for a computer program. Accessibility requirements often are provided within an accessibility specification and specify a minimal set of characteristics for a user interface in order to render the user interface accessible for all users—not just the sighted and unimpaired. As part of most accessibility requirements, a unique label mnemonic is required for each label for each control in a user interface. A label mnemonic refers to an accelerator keystroke assignment for a visual or audible user interface element.

Generally, in a user interface, different user interface elements can be accessed through preferred input methods such as through mouse movements and mouse clicks, or audible selections. In order to accommodate those who are keyboard inclined, or preferred input methods averse, user interface designers provide for an accelerator keystroke responsive to the entry of which can substitute for the use of the preferred direct input method. Oftentimes, the accelerator keystroke is indicated in association with a label mnemonic for the user interface element, for example by underlining a character in the label that suggests the requisite accelerator keystroke.

In the conventional user interface, providing for a label mnemonic often implicates a manual assignment at design time. The manual assignment can be stored along with the specification of the user interface in a resource file. Thereafter, the resource file can be linked into the build of the computer program so as to provide the user interface for the computer program. Accordingly, modifying a label mnemonic can be time consuming in as much as a new build will be required.

The internationalization of a user interface can compound the problem of providing label mnemonics for controls in a user interface. For a single lingual user interface, once the label mnemonics have been manually specified, there is little reason to apply wholesale changes to the label mnemonics and the uniqueness of each can be mostly assured. In the multi-lingual setting, however, ensuring uniqueness can be complicated—especially where the chosen locale is a non-Western locale having a symbolic character set such as those languages common in Asia.

In accommodating label mnemonics for non-Western languages, typically, the label is rendered according to the symbolic character set of the locale and an English language mnemonic follows in parenthesis. Clearly, to ensure uniqueness of the label mnemonics—especially in the context of non-Western languages—involves a great deal of manual intervention. Yet, the ultimate selection of label mnemonics cannot be reused often due to the uniqueness requirement of common accessibility rules. Finally, in that the labels are translated separately as part of properties files, it is not uncommon for duplicate label mnemonics to result.

### BRIEF SUMMARY OF THE INVENTION

Embodiments of the present invention address deficiencies of the art in respect to mnemonic labels and provide a novel and non-obvious method, system and computer program product for multi-lingual dynamic assignment and management of user interface label mnemonics. In one embodiment of the invention, a dynamic label mnemonic assignment method can be provided. The method can include generating a run-time set of label mnemonics for a set of labels in a user interface for a computer program, determining if any of the run-time generated label mnemonics are not unique for the set of label mnemonics, and responsive to determining that any of the run-time generated label mnemonics are not unique for the set of label mnemonics, generating a different set of label mnemonics for the set of labels.

In one aspect of the embodiment, generating a run-time set of label mnemonics for a set of labels in a user interface for a computer program can include selecting a mnemonic allocation method for generating a set of label mnemonics for a corresponding set of labels in a user interface, and applying the selected mnemonic allocation method to the set of labels to produce the set of label mnemonics. In this regard, generating a different set of label mnemonics for the set of labels can include selecting a different mnemonic allocation method for generating a different set of label mnemonics for the corresponding set of labels in a user interface, and applying the different mnemonic allocation method to the set of labels to produce the different set of label mnemonics.

In another aspect of the embodiment, generating a run-time set of label mnemonics for a set of labels in a user interface for a computer program can include detecting a locale for the computer program incorporating a non-Latin character set, translating the set of labels into a language having a Latin character set, and generating the run-time set of label mnemonics for the translated set of labels.

In another embodiment of the invention, a user interface data processing system can be provided. The system can include a user interface for an application. The user interface can include both controls and corresponding labels. The system also can include a mnemonic allocation manager (MAM) coupled to the user interface. The MAM can include program code enabled to generate a run-time set of label mnemonics for the labels, to determine if any of the run-time generated label mnemonics are not unique for the set of label mnemonics, and responsive to determining that any of the run-time generated label mnemonics are not unique for the set of label mnemonics, to generate a different set of label mnemonics for the labels. The system yet further can include one or more mnemonic allocation sets. Each mnemonic allocation set can include a set of label mnemonics for a compartmentalized portion of the user interface.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for multi-lingual dynamic assignment and management of user interface label mnemonics;

FIG. 2A is a flow chart illustrating a process for dynamic assignment and management of user interface label mnemonics; and,

FIG. 2B is a flow chart illustrating a process for multi-lingual dynamic assignment of user interface label mnemonics.

### DETAILED DESCRIPTION OF THE INVENTION

Embodiments of the present invention provide a method, system and computer program product for multi-lingual dynamic assignment of user interface label mnemonics. In accordance with an embodiment of the present invention, label mnemonics can be dynamically applied at run-time to a collection of control labels for a user interface. The applied label mnemonics can be tested for uniqueness before rendering the user interface and label mnemonics can be re-applied upon detecting non-uniqueness. Importantly, non-Latin labels can be translated prior to dynamically applying the label mnemonics and assuring the uniqueness of the dynamically applied label mnemonics. In this way, the accessibility requirement of uniqueness can be enforced for label mnemonics without requiring the tedious, manual maintenance of label mnemonics.

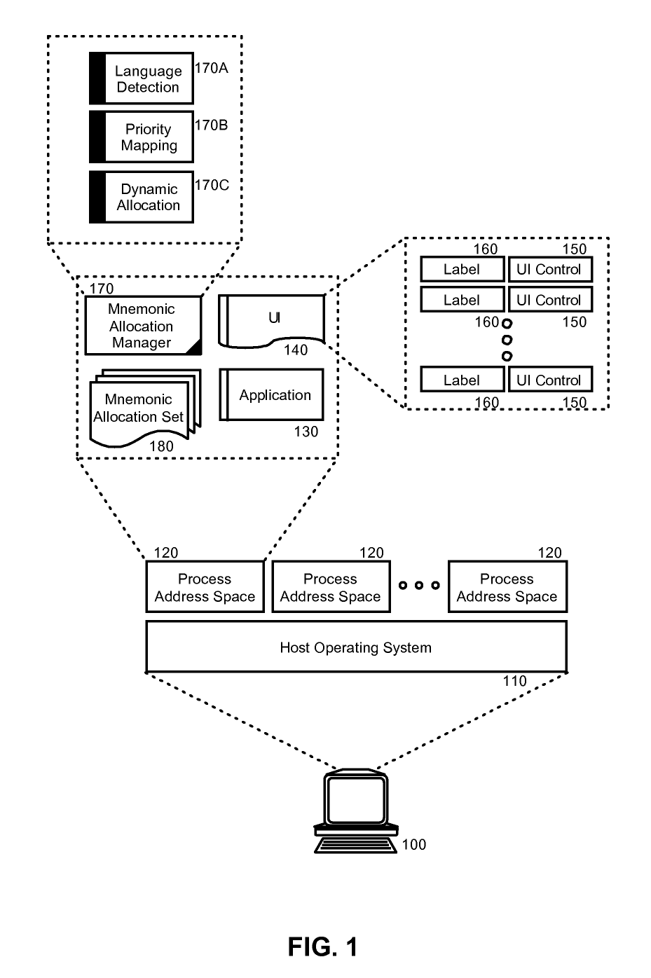

In further illustration, FIG. 1 is a schematic illustration of a data processing system configured for multi-lingual dynamic assignment and management of user interface label mnemonics. The data processing system can include a host computing platform 100 supporting a host operating system 110. The host operating system 110 can manage the operation of one or more process address spaces 120, for instance one or more virtual machines. Each process address space 120 further can support the execution of one or more computing applications 130, each of the computing applications 130 having a user interface 140.

The user interface 140 can include one or more user interface controls 150 and each of the user interface controls 150 can include a label 160 indicating the function or nature of a corresponding one of the user interface controls 150. Each of the user interface controls 150 can include an associated accelerator keystroke. To that end, the label 160 for each corresponding user interface control 150 can include an indication of a label mnemonic. Notwithstanding, in the present invention, the label mnemonic is not statically incorporated into the user interface 140 at design time, but dynamically applied at run time.

In particular, the data processing system can include a mnemonic allocation manager (MAM) 170. The MAM 170 can include program code enabled to determine a mnemonic allocation set 180 for each compartmentalized portion of the user interface, for example a tabbed portion of a dialog box. The mnemonic allocation set 180 for a compartmentalized portion of the user interface 140 can include one or more label mnemonics for one or more corresponding labels 160 as determined dynamically by the MAM 170 to ensure uniqueness amongst all of the label mnemonics for all of the labels 160 in the compartmentalized portion of the user interface 140.

The program code of the MAM 170 can include dynamic allocation logic 170C enabled to parse the labels 160 for corresponding user interface controls 150 in the user interface 140 in order to dynamically determine label mnemonics for the labels 160. Once a label mnemonic has been determined for a label 160, a uniqueness test can be applied to ensure that no other label 160 has been assigned the same label mnemonic. If so, a new strategy can be selected for assigning label mnemonics in order to ensure uniqueness.

Optionally, priority mapping logic 170B can be exercised to apply particular mnemonics to labels 160 on a priority basis for certain labels 160. Specifically, the priority mapping logic 170B can include program code enabled to ensure that a specified label receives a desired label mnemonic as a priority over another label receiving the same label mnemonic. Finally, language detection logic 170A can be utilized to detect a locale for the user interface 140. Based upon whether the locale is a Latin or non-Latin locale, the MAM 170 can apply label mnemonics differently. For example, in the case of a non-Latin locale, the label 150 can be translated into English first, a label mnemonic can be computed second, and the label mnemonic can be applied to the label 160 in parenthesis as part of the label 160.

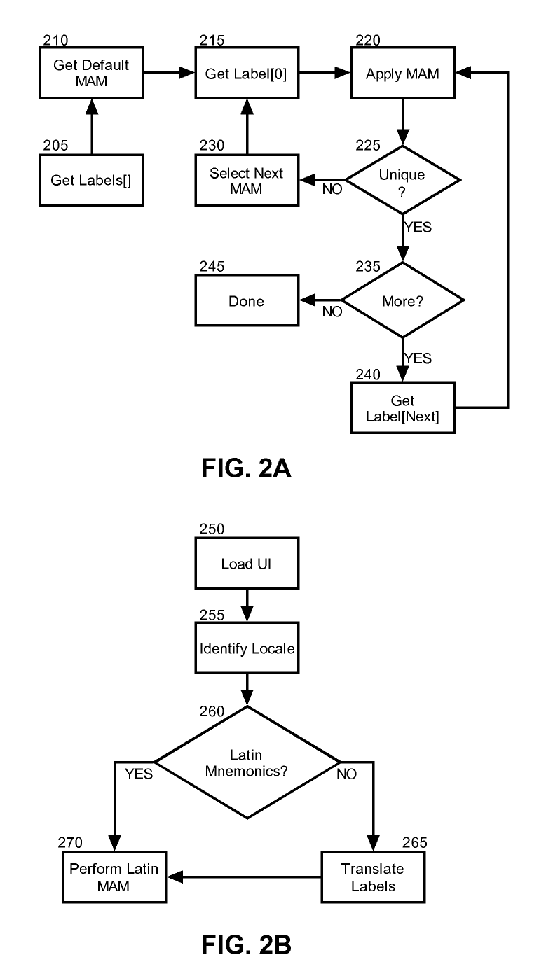

In more particular illustration of the operation of the MAM 170, FIG. 2A is a flow chart illustrating a process for dynamic assignment and management of user interface label mnemonics. Beginning in block 210, a default mnemonic allocation method can be selected for use in computing label mnemonics for a set of labels in a user interface. In block 215, a first label in the set can be selected for processing and in block 220, the mnemonic allocation method can be applied to the selected label to computer a label mnemonic. In decision block 225, it can be determined whether the computed label mnemonic is unique relative to other computer label mnemonics for the set of labels. If not, a new mnemonic allocation method can be selected for use in computing label mnemonics and the process can begin anew in block 215.

In decision block 225, if it is determined that the computed label mnemonic is unique among other label mnemonics computed for the set of labels, in decision block 235 it can be determined if additional labels remain to be processed for the set of labels. If so, in decision block 240 a next label in the set of labels can be selected. Thereafter, the process can repeat through block 220. When no further labels remain to be processed in decision block 235, the process can end in block 245 with a dynamically created set of label mnemonics corresponding to the set of labels in the user interface. Notably, whereas the process illustrated in FIG. 2A pertains generally to a set of labels irrespective of the locale of the application, the process can be further refined through a consideration of the locale for the application.

In yet further illustration, FIG. 2B is a flow chart illustrating a process for multi-lingual dynamic assignment of user interface label mnemonics. Beginning in block 250, a user interface can be loaded for an application. In block 255, a locale can be identified for the application. In decision block 260, if the locale involves a Latin character set, in block 270, mnemonic allocation can be performed utilizing the text of the labels in the user interface as described in the process of FIG. 2A. However, if the locale does not involve a Latin character set, in block 265 the labels of the user interface first can be translated. Thereafter, in block 270, mnemonic allocation can be performed utilizing the translated text of the labels. In this way, non-Latin character sets such as those of Asian locales can be accommodated dynamically according to the present invention.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A dynamic label mnemonic assignment method comprising:
generating a run-time set of label mnemonics for a set of labels in a user interface for a computer program;
determining if any of the run-time generated label mnemonics are not unique for the set of label mnemonics;
responsive to determining that any of the run-time generated label mnemonics are not unique for the set of label mnemonics, generating a different set of label mnemonics for the set of labels; and,
rendering the user interface for the computer program.

2. The method of claim 1, wherein generating a run-time set of label mnemonics for a set of labels in a user interface for a computer program, comprises:
selecting a mnemonic allocation method for generating a set of label mnemonics for a corresponding set of labels in a user interface; and,
applying the selected mnemonic allocation method to the set of labels to produce the set of label mnemonics.

3. The method of claim 2, wherein generating a different set of label mnemonics for the set of labels, comprises:
selecting a different mnemonic allocation method for generating a different set of label mnemonics for the corresponding set of labels in a user interface; and,
applying the different mnemonic allocation method to the set of labels to produce the different set of label mnemonics.

4. The method of claim 1, wherein generating a run-time set of label mnemonics for a set of labels in a user interface for a computer program comprises:
detecting a locale for the computer program incorporating a non-Latin character set;
translating the set of labels into a language having a Latin character set; and,
generating the run-time set of label mnemonics for the translated set of labels.

5. The method of claim 1, wherein generating a run-time set of label mnemonics for a set of labels in a user interface for a computer program, further comprises prioritizing an assignment of a label mnemonic for a particular one of the set of labels.

6. A user interface data processing system comprising:
a user interface for an application, the user interface comprising a plurality of controls and corresponding labels; and,
a mnemonic allocation manager (MAM) coupled to the user interface, the MAM comprising program code enabled to generate a run-time set of label mnemonics for the labels, to determine if any of the run-time generated label mnemonics are not unique for the set of label mnemonics, and responsive to determining that any of the run-time generated label mnemonics are not unique for the set of label mnemonics, to generate a different set of label mnemonics for the labels.

7. The system of claim 6, further comprising a plurality of mnemonic allocation sets, each mnemonic allocation set comprising a set of label mnemonics for a compartmentalized portion of the user interface.

8. The system of claim 6, wherein the MAM further comprises priority mapping logic.

9. The system of claim 6, wherein the MAM further comprises locale detection logic.

10. A computer program product comprising a computer usable medium having computer usable program code for dynamic label mnemonic assignment, the computer program product including:
computer usable program code for generating a run-time set of label mnemonics for a set of labels in a user interface for a computer program;
computer usable program code for determining if any of the run-time generated label mnemonics are not unique for the set of label mnemonics;
computer usable program code for responsive to determining that any of the run-time generated label mnemonics are not unique for the set of label mnemonics, generating a different set of label mnemonics for the set of labels; and,
computer usable program code for rendering the user interface for the computer program.

11. The computer program product of claim 10, wherein the computer usable program code for generating a run-time set of label mnemonics for a set of labels in a user interface for a computer program, comprises:
computer usable program code for selecting a mnemonic allocation method for generating a set of label mnemonics for a corresponding set of labels in a user interface; and,
computer usable program code for applying the selected mnemonic allocation method to the set of labels to produce the set of label mnemonics.

12. The computer program product of claim 11, wherein the computer usable program code for generating a different set of label mnemonics for the set of labels, comprises:
computer usable program code for selecting a different mnemonic allocation method for generating a different set of label mnemonics for the corresponding set of labels in a user interface; and,
computer usable program code for applying the different mnemonic allocation method to the set of labels to produce the different set of label mnemonics.

13. The computer program product of claim 10, wherein the computer usable program code for generating a run-time set of label mnemonics for a set of labels in a user interface for a computer program comprises:
computer usable program code for detecting a locale for the computer program incorporating a non-Latin character set;
computer usable program code for translating the set of labels into a language having a Latin character set; and,
generating the run-time set of label mnemonics for the translated set of labels.

14. The computer program product of claim 10, wherein the computer usable program code for generating a run-time set of label mnemonics for a set of labels in a user interface for a computer program, further comprises computer usable program code for prioritizing an assignment of a label mnemonic for a particular one of the set of labels.
